(19) United States
(12) Patent Application Publication
(10) Pub. No.: US 2006/0273577 A1
(43) Pub. Date: Dec. 7, 2006

(54) Coupling assembly

(76) Inventor: Michael B. Stewart, Bloomfield Hills, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/130,619

(22) Filed: May 17, 2005

(51) Int. Cl. F16L 55/00

(52) U.S. Cl. 285/39

(57) ABSTRACT

A threadless coupling includes a first member and a second member and a split locking ring disposed there between. The first member includes an exterior surface with a rib extending away therefrom. The rib includes a first apex, a second apex and a groove disposed between the first apex and the second apex. The locking ring selectively goes over one of the apexes, engages and then disengages from the groove and then goes over the other apex.

### BACKGROUND OF THE INVENTION

Threadless high pressure-capable coupling assemblies are known. U.S. Pat. Nos. 5,226,682, 5,553,895, and 5,570,910 and the couplings disclosed therein, are incorporated herein by reference in their entirety.

As known in the prior art, a male coupling member may be connected to a female coupling member by way of a split locking ring selectively disposed there between. The locking ring has a first end and a second end, the first and second ends being aligned to permit selective abutting engagement, the ring generally biased to facilitate the ends being in engagement. The male coupling member has a rib consisting of a ramp, an apex and a shoulder. The apex may have some radiusing or have a surface generally parallel to a longitudinal axis of the member. In turn, the female member has a ring receiving groove and some type of retaining groove adjacent to the ring receiving groove. The ring is disposed into the ring receiving groove prior to connecting the male coupling member to the female coupling member. When the male coupling member is inserted into the female coupling member, the ring travels up the ramp over the apex and down the shoulder to become secured between the shoulder of the male member and the retaining groove of the female member. Ideally, the ring is subjected to compressive forces about essentially its entire circumference in reaction to the pressures imposed within the coupling, the area of contact helping to distribute the pressure generally uniformly about the ring circumference.

While current coupling assemblies generally work well, it would be desirable to minimize any potential for ring misalignment as it goes over the rib of the male coupling member since such misalignment could result in less than essentially the entire circumference of the ring being subjected to compressive forces during coupling operation. If the area of contact is reduced, the resulting forces are increased if the pressure is generally constant, which could result in premature wear.

Further, even if ring alignment is not an issue, there is a desire for either tactile or sound-based feedback that lets a user know when the coupling is just about ready to complete the coupling or decoupling process.

### SUMMARY OF THE INVENTION

A threadless coupling assembly is disclosed that includes a first member and a second member with a split locking ring selectively disposed there between. The first member includes an exterior surface and a rib extending away from the exterior surface and including a first apex, a second apex, and a groove disposed between the first apex and the second apex. The locking ring selectively goes over the first apex into the groove and then over the second apex as the coupling is engaged. Similarly, the locking ring selectively goes over the second apex into the groove and then over the first apex as the coupling is disengaged.

### BRIEF DESCRIPTION OF THE DRAWINGS

FIG. 1 is an elevational view of a first embodiment of a male member and female member of a coupling assembly in the fully coupled position by way of a locking ring.

FIG. 2A is a fragmentary elevational view of the male member formed according to a first embodiment showing specifically a rib portion.

FIG. 2B is a fragmentary elevational view of the male member formed according to a second embodiment showing specifically an alternative rib portion.

FIG. 3A is an enlarged fragmentary view of the first embodiment of the coupling assembly in the fully coupled position with the locking ring disposed between a retaining groove of the female member in the form of a chamfer and a shoulder of the male member.

FIG. 3B is an enlarged fragmentary view of a second embodiment of the female member showing the locking ring disposed between a retaining groove of the female member in the form of a chamfer and a separate base, and a shoulder of the male member.

FIG. 3C is an enlarged fragmentary view of a third embodiment of the female member showing the locking ring disposed between a retaining groove of the female member and a shoulder of male member.

FIG. 4 is a fragmentary view of the male member being inserted into the female member and showing the locking ring disposed against a front wall of a receiving groove of the female member and positioned in a groove of the rib between a front apex and a rear apex of the rib portion.

### DESCRIPTION OF PREFERRED EMBODIMENTS

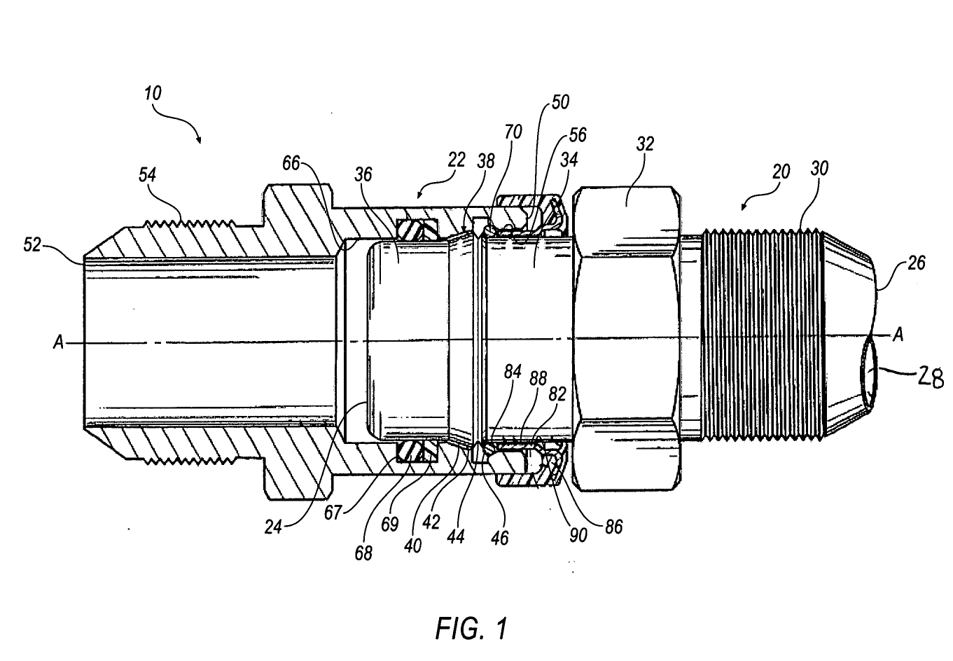

FIGS. 1, 2A, 3A and 4 disclose a coupling assembly 10 in accordance with a first embodiment illustrating a generally cylindrical male member 20 and a generally cylindrical female member 22 extending along a longitudinal axis A-A. The male and female members 20 and 22 can be formed of metal, such as steel.

The male member 20 extends from a leading end 24 intended for insertion in the female member 22 to a trailing end 26 and has a passageway 28 extending there through. If desired, the trailing end 26 may be provided with external threads 30 for attachment to a threaded coupling (not shown) and a series of flats 32 defining a hexagonal cross section for engagement by a wrench.

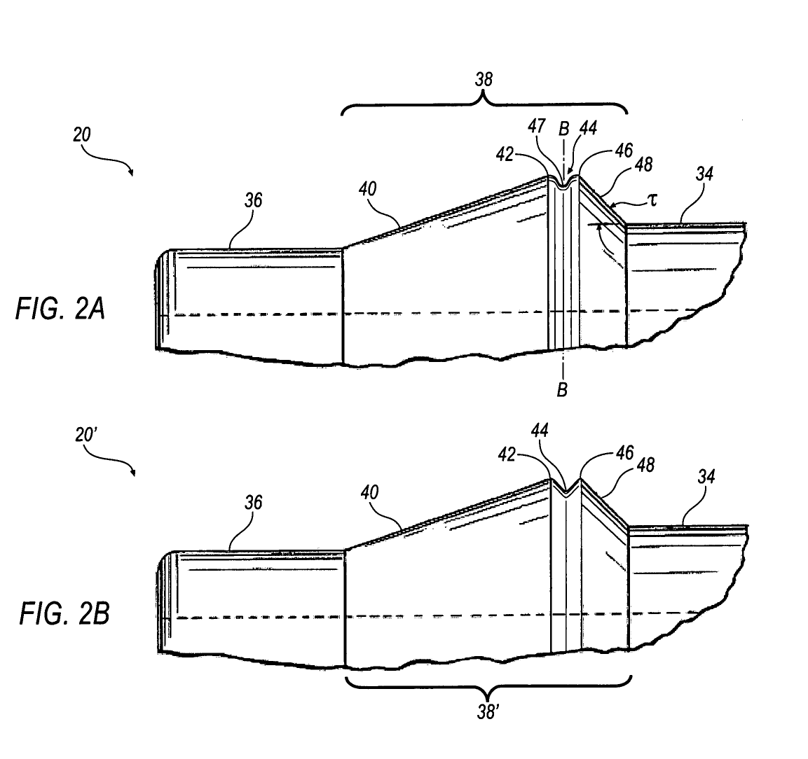

Forwardly of the hexagonal cross section defined by the flats 32, the male member 20 has a trailing exterior surface 34 and a leading exterior surface 36 which are separated by a rib 38, which is preferably integral with the male member 20. Rib 38 includes a tapered ramp 40 extending rearwardly and outwardly from the leading exterior surface 36 at an angle relative to the axis A-A. The ramp 40 extends to a forward apex 42, the apex defining a first wall of a groove 44. A rear apex 46 defines a second wall of the groove 44. A base 47 of groove 44 between the two walls preferably terminates at a diameter at least slightly greater than both trailing exterior surface 34 and leading exterior surface 36. The final portion of the rib 38 is a shoulder 48 that tapers rearwardly and inwardly from the apex 46 to meet the trailing exterior surface 34. Thus, apexes 42 and 46 along with groove 44 connect ramp 40 to shoulder 48. As best illustrated in FIG. 2A, the apexes 42, 46 and the bottom of groove 44 are radiused in a first embodiment while the degree of radiusing is much less in the alternative embodiment of a male member 20′ in FIG. 2B. In general, at least some radiusing is desired to minimize material wear over time during the locking and unlocking of coupling assembly 10 as discussed below.

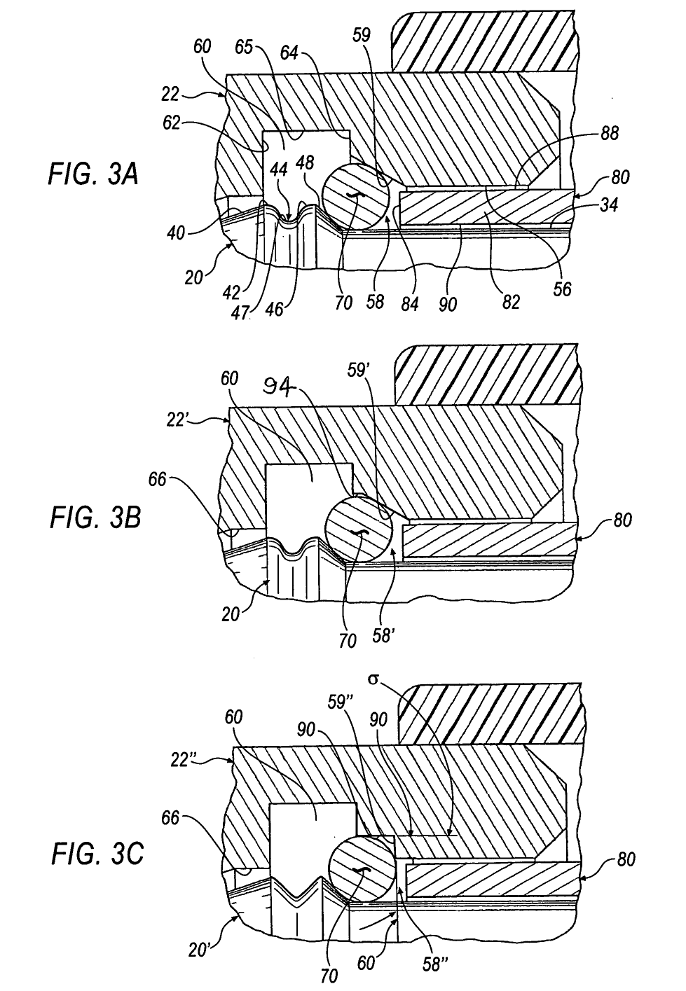

As best illustrated in FIGS. 1 and 3A, the female member 22 extends from a receiving end 50 to a remote end 52 that may have adjacent thereto external threads 54 or other suitable connection mechanisms for fastening to a separate connection (not shown). The portion of the second female member 22 adjacent the receiving end 50 is provided with an interior surface 56. Disposed adjacent to interior surface 56 and longitudinally inwardly of receiving end 50 is a retaining groove 58 in the form of a chamfer 59. Disposed adjacent retaining groove 58 is a receiving groove 60 closer to remote end 52 than either retaining groove 58 or interior surface 56. In the illustrated embodiment, receiving groove 60 is defined by two generally radially extending walls 62, 64 and a generally longitudinally extending base 65 disposed there between. Finally, an interior surface 66 is disposed between remote end 52 and receiving end 50 and including an annular groove 67 for receiving an annular seal 68 and a rigid plastic ring 69.

The greatest radial extent of interior surface 56 is less than the greatest radial extent of retaining groove 58. In turn, the greatest radial extent of receiving groove 60 is greater than the greatest radial extent of retaining groove 58. The interior surface 66 has a radial extent less than interior surface 56. In practice, it is only slightly greater in diameter than the leading exterior surface 36 with seal 68 and ring 69 helping to provide a leak proof seal between male member 20 and female member 22.

A split locking ring 70, best shown in FIGS. 1, 3 and 4, is used to selectively lock male member 20 to female member 22. Split locking ring 70 is formed of any appropriate material including a spring tempered stainless steel or a spring tempered phosphoric bronze material. The split locking ring 70 is provided with a first end portion and a second end portion. The split locking ring 70, when coupling assembly 10 is completely disassembled, has an external diameter smaller than the greatest diameter defined by the outermost radial portion of receiving groove 60, but larger than the diameter of the interior cylindrical surface 56. The split locking ring 70 has an internal diameter substantially equal to or, preferably, slightly smaller than that of the trailing exterior surface 34 of the male member 20 to snugly engage the trailing exterior surface 34 when the male member 20 is engaged to the female member 22. As a result, the internal diameter of the split locking ring 70 is significantly smaller than the diameter of apexes 42 and 46 of rib 38. The split locking ring 70, by virtue of its dimensions, will be retained in the receiving groove 60 when the first male member 20 is disconnected from the second female member 22. However, by virtue of its being split, the diametrical size of the locking ring 70 may be expanded and the end portions become separated as the locking ring 70 engages with and moves over rib 38 upon insertion of the first male member 20 into the second female member 22. When coupling assembly 10 is locked, preferably the end portions of locking ring 70 are either abutting or in a closely adjacent orientation. Once again, however, upon unlocking coupling assembly 10, the diametrical size of locking ring 70 is expanded and the end portions 72 and 74 become separated as the locking ring once again engages with and moves over rib 38. Thus, ring 70 is generally biased to a closed position. The operation of locking and unlocking coupling assembly 10 is discussed in more detail below.

A release sleeve 80 facilitates the unlocking of coupling assembly 10. In one embodiment, release sleeve 80 includes a forward metal portion 82 terminating at a leading end 84 and a thermoplastic and/or elastomeric (TPE) portion 86. Much like locking ring 70, release sleeve 80 is preferably split. An exterior surface 88 defines a radially outer diameter that is less than the corresponding diameter of interior surface 56 of female member 22, and an interior surface 90 defines a diameter in the form of a radially inner surface 92 that is greater than a corresponding diameter of trailing exterior surface 34 of male member 20, permitting the release sleeve to move longitudinally along axis A-A.

The various dimensions of male member 20, female member 22 locking ring 70, and release sleeve 80 are optimized to facilitate the locking and unlocking of coupling assembly 10.

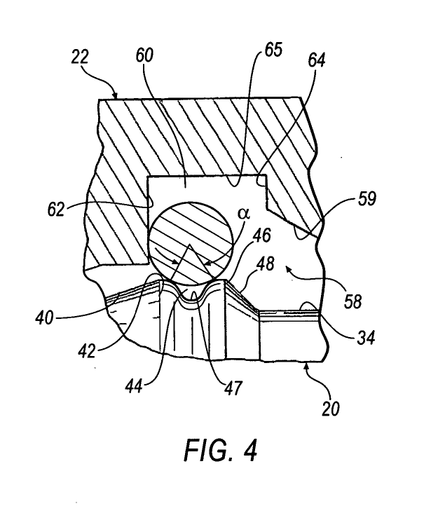

To lock coupling assembly 10, male member 20 is inserted into female member 22. The leading end 24 and leading exterior surface 36 pass through split locking ring 70, which is located in receiving groove 60 such that the ring at least engages wall 62. As the male member 20 continues its inward movement, ring 70 engages ramp 40, causing the ring to expand, thereby opening the gap between the end portions of the ring in increasing amounts as the locking ring moves up to the maximum diameter of ramp 40 and over forward apex 42. As shown in FIG. 4, once the ring 70 goes over the apex 42 it then engages groove 44 between apexes 42 and 46. Once it engages groove 44, further insertion of the male member 20 into female member 22 causes ring 70 to go over the rear apex 46 and engage shoulder 48. Ring 70 will move downwardly of the shoulder 48 with the end portions of ring 70 converging until ring 70 selectively contacts trailing exterior surface 34. When ring 70 contacts retaining groove 58, the ring settles into a locked position and is trapped between shoulder 48, trailing exterior surface 34 and retaining groove 58. In the case of the first embodiment, ring 70 engages chamfer 59 of retaining groove 58. The application of pressure will facilitate the locking of male member 20 with respect to female member 22 by way of the force transmission through locking ring 70 in binding engagement with retaining groove 58. Increasing pressure merely helps to further lock the two members 20,22 together.

The shoulder 48 should preferably taper at an angle τ in the range of approximately thirty-five (35) degrees to fifty-five (55) degrees relative to the axis A-A and more preferably at an angle of about forty-five (45) degrees. The corresponding angle of ramp 40 is typically much less than the angle τ, but will depend on the application and nature of the mating components.

To unlock coupling assembly 10, pressure within the coupling assembly 10 is released. Female member 22 is then moved toward trailing end 26 to release split locking ring 70 from engagement with retaining groove 58. End 84 of release sleeve 80 is moved toward retaining groove 58. The leading end 84 urges the locking ring 70 radially outwardly up the shoulder 48 over apex 46 to engage groove 44. As the two members are separated, the ring leaves groove 44, goes over apex 42 and down ramp 40.

The combination of apexes 42, 46 and groove 44 provides a number of significant advantages. First, there is sometimes a tendency for ring 70 to be cocked and potentially misaligned as male member 20 is inserted into or released from female member 22. Groove 44 helps to realign the ring 70 before it settles into its ultimate locked or unlocked position. Further, depending on the relative size of apexes 42, 46, groove 44 and the cross-sectional dimension of ring 70, tactile feedback and/or sound generation between the mating components provide a positive indication that any further insertion will result in locking of coupling assembly 10 or of final unlocking upon uncoupling.

It is important that the longitudinal and radial extent of groove 44 be carefully controlled, however, so that locking ring 70 does not become accidentally trapped in the groove either upon coupling locking or coupling unlocking. If the radial and/or longitudinal extent of groove 44 is too large relative to the corresponding dimensions of ring 70, the ring may not readily leave the groove to go over apex 46 as the coupling is locked. Similarly, the ring 70 may not readily disengage from groove 44 to go over apex 42 as the coupling 10 is unlocked. Moreover, as shown in FIG. 4, ring 70 must maintain its relative position within receiving groove 60 such that improper binding does not take place between the ring and the walls 62 or 64 of the receiving groove.

In one disclosed embodiment, when locking ring 70 engages groove 44, the two locations of contact between apexes 42 and 46, respectively, spans a circumferential segment of the outer circumference of the ring of an angle α. If ring 70 is generally circular, the circumferential segment is typically a chord with a minor arc α of less than one-hundred and eighty (180) degrees. Preferably, however, a is no more than approximately sixty (60) degrees. More preferably, the maximum angle α is no more than approximately on the order of twenty (20) to forty (40) degrees. In practice, the angle α should be selected to be as small as possible to facilitate ready movement of the ring 70 into and out of groove 44 while still providing the desired alignment and positioning feedback discussed above. Modifications to ring 70 as well as to the components of groove 44, including apexes 42, 46 and base 47 and their relative positions to one another and the rest of coupling assembly 10 can affect angle α.

In another disclosed embodiment, ring 70 may engage or be closely adjacent to base 47. However, in such an embodiment, the depth and longitudinal extent of groove 44 in relation to the relative cross-sectional size of ring 70 must be very carefully controlled to avoid accidental and undesirable trapping of ring 70 as it attempts to ride up apex 46 upon insertion or up apex 42 upon disconnection.

Further, as shown in FIG. 2A, apexes 42 and 46 preferably have a sufficient radiusing to facilitate movement of the ring 70 into and out of groove 44. In contrast, less radiusing of apexes 42′ and 46′ is shown in the alternative embodiment of male member 20′ in FIG. 2B.

Apexes 42 and 46 are preferably generally symmetrical with respect to a line of symmetry B-B, generally perpendicular to line A-A, defined by groove 44 as shown in FIG. 2A, recognizing, however, that ramp 40 and shoulder 48 have dissimilar characteristics. The advantage of having at least rough symmetry in the form of similar radial, longitudinal and cross-sectional characteristics adjacent groove 44 is to balance ring 70 within the groove. Under some circumstances, however, the dimensions of the two apexes 42, 46 may be dissimilar. For example, it may be desirable to have additional tactile and/or sound generation upon insertion of male member 20 into female member 22 and less when the two members are separated. It may also be more desirable to make it easier or harder to engage or separate the coupling assembly 10. In such a situation, for example, apex 42 may have a greater radial extent than apex 46. Such a larger apex 42 may also result in additional force being required to separate the two components as ring 70 is forced over apex 42 from groove 44 and onto ramp 40.

While retaining groove 58 is defined in part by chamfer 59 in FIG. 3A, other retaining grooves are envisioned in alternative embodiments. For example, in FIGS. 3B and 3C, retaining groove 58′ includes a chamfer 59′ or 59″ and a separate base 94 disposed between the chamfer and receiving groove 60. Base 94 may be dimensioned and positioned to participate in securing ring 70 in normal operation, as shown in the embodiment of FIG. 3C, where the angle σ of the chamfer 59″ with respect to an axis parallel to axis A-A may be as great as ninety (90) degrees. Alternatively, if base 94 is only provided as a secondary locking surface in case of accidental failure between trailing exterior surface 34 and shoulder 48 of male member 20 and chamfer 59′, the angle σ is typically on the order of twenty (20) degrees to forty (40) degrees and preferably around thirty (30) degrees.

The present exemplary coupling assembly and related components such as the male member are merely illustrative of the best modes presently established for carrying out the claimed subject matter. It should be understood by those skilled in the art that various alternatives to the embodiments of the disclosed coupling assembly or related components described herein may be employed without departing from the spirit and scope thereof as defined in the following claims. As merely one example, apexes 42, 46 may be radially segmented around the circumference of male member 20 to reduce friction between ring 70 and the walls of groove 44 while ensuring the desired engagement between ring 70 and groove 44.

It is intended that the following claims define the scope of the coupling assembly or related components and that the claimed subject within the scope of these claims and their equivalents be covered thereby. This description should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. A coupling assembly for connecting two members comprising in combination:
(a) a split locking ring;
(b) a first member extending along an axis from a forward end toward a rearward end and having an exterior surface, a rib extending outwardly from said exterior surface, said rib including
(i) a first apex,
(ii) a second apex positioned rearwardly of said first apex, and
(iii) a groove disposed between said first apex and said second apex, and
(c) a second member extending from a receiving end to a remote end;
wherein said first member and said second member are sized such that upon insertion of said first member into said second member, said split locking ring travels over said first apex, engaging and then disengaging from said groove and then over said second apex.

2. A coupling assembly as recited in claim 1, wherein said rib provides at least one of tactile or sound feedback as said ring travels over said rib as said coupling assembly is either locked or unlocked.

3. A coupling assembly as recited in claim 1, wherein when said ring engages said groove and there are two locations of contact between said first apex and said second apex, the circumferential segment of the outer circumference of the ring defined there between is less than one hundred and eight (180) degrees.

4. A coupling assembly as recited in claim 3, wherein a cross-section of said ring is generally circular such that the circumferential segment is a chord with a minor arc.

5. A coupling assembly as recited in claim 4, wherein said minor arc is no more than approximately sixty (60) degrees.

6. A coupling assembly as recited in claim 5, wherein said minor arc is no more than in the range of approximately twenty (20) degrees to forty (40) degrees.

7. A coupling assembly as recited in claim 1, wherein said first apex and said second apex extend outwardly from said exterior surface generally to the same extent.

8. A coupling assembly as recited in claim 1, wherein said first apex and said second apex are generally symmetrical with respect to a line of symmetry defined by said groove.

9. A male member for use with a coupling assembly comprising:
a base exterior surface; and
a rib extending away from said base exterior surface and including
(i) a first apex,
(ii) a second apex, and
(iii) a groove disposed between said first apex and said second apex.

10. A male member as recited in claim 9, wherein said rib includes a ramp disposed forwardly of said first apex.

11. A male member as recited in claim 9, wherein said rib includes a shoulder disposed rearwardly of said second apex.

12. A male member as recited in claim 9, wherein said rib includes a ramp positioned forwardly of said first apex and a shoulder positioned rearwardly of said second apex, said ramp being dissimilar from said shoulder.

13. A male member as recited in claim 9, wherein said first apex and said second apex share a generally common radial extent.

14. A male member as recited in claim 9, wherein said apex and said second apex are generally symmetrical with respect to a line of symmetry defined by said groove.

15. A coupling assembly for connecting two members comprising in combination:
(a) a split locking ring having a first end and a second end, said first and second ends being aligned to permit abutting engagement, said ring being expandable to define a gap between said first and second ends;
(b) a male member extending along an axis from a forward end toward a rearward end and having an exterior surface, a rib extending outwardly from said exterior surface, said rib including
(i) a ramp tapering outwardly in a direction away from said forward end and away from said axis,
(ii) a first apex positioned rearwardly from said ramp,
(iii) a second apex positioned rearwardly of said first apex,
(iv) a groove disposed between said first apex and said second apex, and
(iii) a shoulder tapering rearwardly away from said second apex and inwardly toward said axis, said first apex, said groove and said second apex connecting said ramp and said shoulder; and
(c) a female member extending from a receiving end to a remote end and including a receiving groove and a retaining groove;
said split locking ring being selectively receivable in said receiving groove and said retaining groove as said coupling assembly is selectively locked or unlocked; and
said male member and female member being sized such that upon insertion of said male member into said female member, said split locking ring travels up said ramp to increase the size of said gap, over said rib and contracts to reduce the size of said gap and to engage said shoulder, becoming trapped between said shoulder and said retaining groove.

16. A coupling assembly as recited in claim 15, wherein when said ring engages said groove and there are two locations of contact between said first apex and said second apex, the circumferential segment of the outer circumference of the ring defined there between is less than one hundred and eight (180) degrees.

17. A coupling assembly as recited in claim 16, wherein said minor arc is no more than approximately sixty (60) degrees.

18. A coupling assembly as recited in claim 15, wherein said rib provides at least one of tactile or sound feedback as said ring travels over said rib and engages said groove as said coupling assembly is either locked or unlocked.

19. A coupling assembly as recited in claim 15, wherein said first apex and said second apex share a generally common radial extent.

20. A coupling assembly as recited in claim 15 wherein said apex and said second apex are generally symmetrical with respect to a line of symmetry defined by said groove.
